(19) United States
(12) Patent Application Publication
(10) Pub. No.: US 2004/0019521 A1
(43) Pub. Date: Jan. 29, 2004

(54) System and method for advertising products and services on computer readable removable medium

(76) Inventor: Robert K. Birmingham, Palm City, FL (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(21) Appl. No.: 10/266,438

(22) Filed: Oct. 7, 2002

Related U.S. Application Data
(60) Provisional application No. 60/398,285, filed on Jul. 25, 2002.
(60) Provisional application No. 60/402,619, filed on Aug. 12, 2002.

(51) Int. Cl. G06F 17/60

(52) U.S. Cl. 705/14

(57) ABSTRACT

A system, method and computer-readable removable medium for advertising products and services is disclosed. In an embodiment of the present invention, the computer-readable removable medium includes computer instructions for providing metadata associated with establishments located in a predefined geographical area that sell products and services. The computer-readable medium includes metadata associated with establishments that pay to be listed and establishments that do not pay to be listed. The computer-readable removable medium further includes computer instructions for searching establishments by name, type and location. The computer-readable removable medium further includes coupons for discounted products or services at the establishments that are listed. The computer-readable removable medium is a Compact Disc (CD) or a Digital Versatile Disc (DVD). In addition, the advertised establishments are any one of restaurants, hotels, movie theaters, nightclubs, retail shops and theme parks.

### CROSS REFERENCE TO RELATED APPLICATIONS

The subject matter of the present application is related to the subject matter of U.S. Provisional Application No. 60/398,285 entitled LetsGO and filed on Jul. 25, 2002 and U.S. Provisional Application No. 60/402,619 entitled Let'sGo and filed on Aug. 12, 2002, each of which are hereby incorporated by reference in their entirety.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### BACKGROUND OF THE INVENTION

1. Field of the Invention

This invention generally relates to the field of targeted advertising and more specifically to advertising using removable media, such as CDs, DVDs, and equivalents that may be read by a computer, a DVD player or a game console.

2. Description of Related Art

Current techniques for advertising products and services, such as restaurants and hotels, involve television and print advertising. Advertising on television and print, however, involves a hit-or-miss element due to the mass broadcast quality of these techniques. Television and print advertising techniques, therefore, lack the ability to adequately target the relevant consumer base for the products and services being advertised. In addition, print advertising media such as the Yellow Pages business directory does not solve the problem of finding suitable products or services when a consumer does not know which to choose from a multitude of products and services. Further, business directories can be cumbersome and time consuming to use. Lastly, these techniques involve a fixed medium, which becomes outdated when new information becomes available.

Another technique for advertising products and services involves the Internet. A consumer can visit a particular web site to gather more information on a product or service. This technique, however, does not solve the problem of finding a suitable product or service when a consumer does not know which of a multitude of products and services to choose. Further, business web sites can be non-user friendly and cumbersome to use. Also, the use of the Internet can involve network latencies and connection problems, which add to the burden of using this medium.

Another technique involves advertising in a Yellow Pages-like business directory on the Internet. This technique, however, suffers from the same problems as print Yellow Pages directories such as the problem of finding suitable product or services and not having enough information to make informed decisions. Moreover, the use of Yellow Pages on the Internet today does not incorporate helpful rich multimedia features including real-time video tours, virtual tours or other metadata such as displaying a menu for a particular restaurant. Lastly, many households are not equipped with an Internet connection. Currently only about 50% of the households in the U.S. have Internet connection. Moreover, the number of households that have broadband connection is less than 10%. Accordingly, the use of the Internet as a delivery mechanism for advertising excludes a large portion of the population.

Therefore, a need exists to overcome the problems with the prior art as discussed above.

### SUMMARY OF THE INVENTION

Briefly, in accordance with the present invention, disclosed is a system, method and computer-readable removable medium for advertising products and services. In an embodiment of the present invention, the computer-readable removable medium includes computer instructions for providing metadata associated with establishments located in a geographical area that sell products and services. The computer-readable removable medium includes metadata on establishments that pay to be listed and establishments that do not pay to be listed. The computer-readable removable medium further includes computer instructions for searching establishments by name, type and location and by metadata. If the computer-readable removable medium is provided for a fee, coupons for discounted products or services at the establishments that are listed are provided.

In an embodiment of the present invention, the computer-readable removable medium is a Compact Disc (CD) or a Digital Versatile Disc (DVD). In addition, the advertised establishments are any one of restaurants, hotels, movie theaters, nightclubs, retail shops, theme parks and more. Also, the computer-readable removable medium is offered on a subscription basis (such as once a month or bimonthly) or a non-subscription basis.

The described embodiments of the present invention are advantageous as they allow for consumers to quickly and easily find suitable products and services from the comfort of their home. Another advantage of the present invention is that the advertising medium is updated regularly in order to keep consumers apprised of changes to establishments. Yet another advantage of the present invention is that the user is allowed to search for a suitable product or service using a variety of search parameters, resulting in a more accurate match for the consumer. Yet another advantage of the present invention is that a CD or DVD allows for an enormous amount of information to be stored on the computer readable removable medium, allowing for greater and more detailed information to be stored regarding products and services. The information includes real time video and audio and other multimedia information, which is all searchable. Yet another advantage of the present invention is that the computer readable removable medium is small, compact and can be easily transported and exchanged among consumers.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2 is an organizational chart showing the logical arrangement of restaurant information on computer-readable removable media, in accordance with one embodiment of the present invention.

FIG. 3 is an organizational chart showing the logical arrangement of movie information on computer-readable removable media, in accordance with one embodiment of the present invention.

FIG. 4 is an illustration of a main menu screen for navigating product and service information on a CD/DVD, in accordance with one embodiment of the present invention.

FIG. 5 is an illustration of a main restaurant search screen for navigating restaurant information on a CD/DVD, in accordance with one embodiment of the present invention.

FIG. 6 is an illustration of a restaurant search by name screen for navigating restaurant information on a CD/DVD, in accordance with one embodiment of the present invention.

FIG. 7 is an illustration of a restaurant search by location screen for navigating restaurant information on a CD/DVD, in accordance with one embodiment of the present invention.

FIG. 8 is an illustration of a restaurant search by type screen for navigating restaurant information on a CD/DVD, in accordance with one embodiment of the present invention.

FIG. 9 is an illustration of a restaurant information screen for viewing restaurant information on a CD/DVD, in accordance with one embodiment of the present invention.

FIG. 10 is a block diagram of a computer system useful for implementing the present invention.

FIG. 11 is a screenshot of a main menu screen for navigating product and service information on a CD/DVD, in accordance with one embodiment of the present invention.

FIG. 12 is a screenshot of a main restaurant search screen for navigating restaurant information on a CD/DVD, in accordance with one embodiment of the present invention.

FIG. 13 is a screenshot of a restaurant search by name screen for navigating restaurant information on a CD/DVD, in accordance with one embodiment of the present invention.

FIG. 14 is a screenshot of a restaurant search by location screen for navigating restaurant information on a CD/DVD, in accordance with one embodiment of the present invention.

FIG. 15 is a screenshot of a restaurant search by type screen for navigating restaurant information on a CD/DVD, in accordance with one embodiment of the present invention.

### DESCRIPTION OF THE PREFERRED EMBODIMENTS

Overview

A system, method and computer-readable removable medium for advertising products and services (for restaurants, hotels, movie theaters, nightclubs, retail shops and theme parks, etc.) is provided. The computer-readable removable medium is a CD or DVD that provides metadata (such as an address and telephone number, operating hours, a text description, driving directions, a map, a video showing the establishment, a link to a web site of the establishment and a review of the establishment) associated with the establishments located in a predefined geographical area (such as a zip code, an area code, a political subdivision, latitude and longitude) or associated with a product or service category (such as clothing stores, dry-cleaners, yacht sales, etc.). The CD or DVD includes metadata on establishments that pay to be listed and establishments that do not pay to be listed. The CD or DVD also allows searching the establishments by name, type and location. The CD or DVD also includes coupons for discounted products or services at the establishments that are listed.

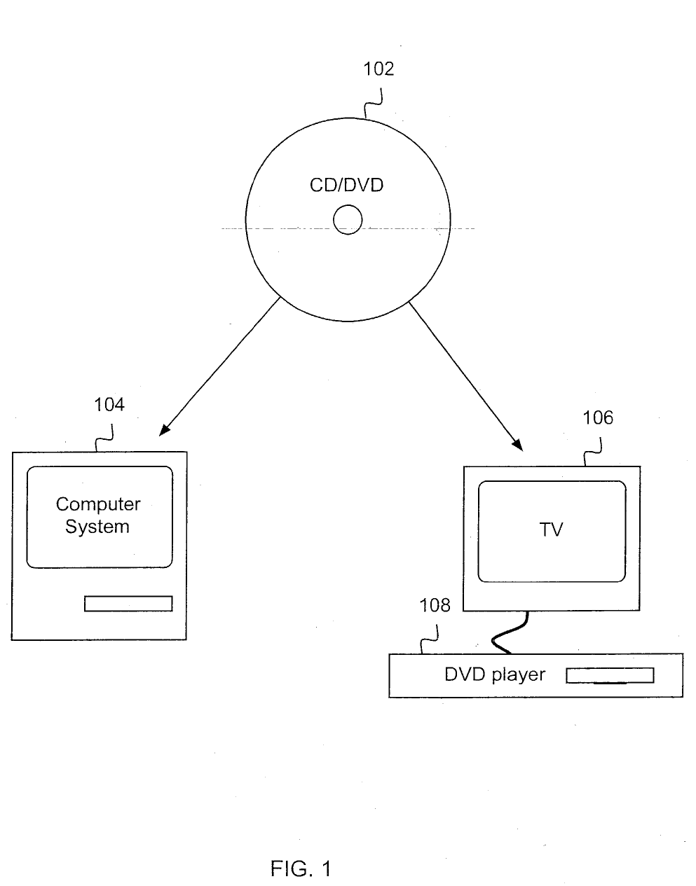

FIG. 1 is a block diagram illustrating the overall system architecture of one embodiment of the present invention. FIG. 1 shows a computer 104, a television set 106, a DVD player 108 and a CD or DVD 102. The CD/DVD 102 is placed in the computer 104 or a television set 106/DVD player 108 combination and executed. Subsequently, the user is able to view the information on the CD/DVD 102.

The computer system 104 on which CD/DVD 102 executes comprises one or more Personal Computers (PCs) (e.g., IBM or compatible PC workstations running the Microsoft Windows 95/98/2000/ME/CE/NT/XP operating system, Macintosh computers running the Mac OS operating system, or equivalent), game consoles (such as the Sony PlayStation X/2 or the Microsoft Xbox) or any other computer processing devices capable of executing a CD/DVD 102. In another embodiment of the present invention, the computer system 104 on which CD/DVD 102 executes is one or more server systems (e.g., SUN Ultra workstations running the SunOS or AIX operating system or IBM RS/6000 workstations and servers running the AIX operating system). The television 106 is a commercially available NTSC or PAL television set. Likewise, the DVD player 108 is a commercially available DVD player.

In the instance of a CD, CD 102 includes files that are viewed using applications on the computer system 104. In one example, the CD 102 includes a set of HTML files that are viewed using a web browser such as Netscape Communicator or Microsoft Internet Explorer. Video (in any of the video formats or video compression formats, such as MPEG, MPEG2, MPEG4, MPEG7, Microsoft Windows Media Player, QuickTime, DV and AVI) is included in the HTML files and is viewed using appropriate media players. Audio, in the form of MP3 or WAV files, is included in the HTML files and is executed using appropriate media players. In another example, the CD 102 includes a set of related PDF files that are viewed using Adobe Acrobat. Video and audio are included in the PDF files and are executed using appropriate media players.

In the instance of a DVD, DVD 102 includes a standardized set of files that are executed using the DVD standard by the computer 104 (which must support DVD playback) or the DVD player 108. The DVD standard allows for playing of audio, video and text while allowing a user to navigate the information on the DVD 102 using a mouse or a control (a remote control or a hand controller).

In one embodiment of the present invention, the CD/DVD 102 is provided to consumers on a fee basis. For example, the CD/DVD 102 is provided as a fee-based subscription wherein a new CD/DVD 102 is produced with updated information every month. In this embodiment, the CD/DVD 102 is offered in conjunction with coupons for discounted products or services sold by the establishments featured in the CD/DVD 102. A coupon is a promotional code, a secret phrase or a key that is used to identify the source of the CD/DVD 102. The coupon is used when a consumer purchases a product or service from a listed establishment, in order to obtain a discount or a free product or service. The CD/DVD 102 is also offered in conjunction with another product in order to enhance the value of the product. For example, a hotel offer the CD/DVD 102 to its guests for free, in order to improve the guests' experience in the city while staying at the hotel.

In another embodiment of the present invention, the CD/DVD 102 is provided to consumers on a rental basis. For example, the CD/DVD 102 is provided as a rental from a movie rental store such as Blockbuster or Hollywood Video. In this embodiment, the CD/DVD 102 is provided on a fee basis or for free. The CD/DVD 102 is offered in conjunction with coupons for discounted products or services sold by the establishments featured in the CD/DVD 102. The CD/DVD 102 is also offered in conjunction with another product in order to enhance the value of the product.

In another embodiment of the present invention, the CD/DVD 102 is provided to consumers for free. For example, the CD/DVD 102 is distributed to consumers in a targeted manner, such as by location or demographics. The CD/DVD 102 is offered in conjunction with coupons for discounted products or services sold by the establishments featured in the CD/DVD 102. The CD/DVD 102 is also offered in conjunction with another product in order to enhance the value of the product. For example, a movie rental establishment offers the CD/DVD 102 for free when a consumer rents a movie, thereby enhancing the value to the consumer of renting the movie.

In another embodiment of the present invention, all establishments in a predefined geographical area, or pertaining to a particular category of products or services, are listed in the CD/DVD 102. This is performed for no fee or for a standard fee. The establishment may opt to include additional metadata in the CD/DVD 102 for a greater fee, proportional to the amount of additional metadata included. In addition, the establishment may opt to include additional coupons for the establishment in the CD/DVD 102 for a greater fee, proportional to the amount of additional coupons included. Also, the establishment may opt to receive higher search engine rankings when a user performs a search for an establishment on the CD/DVD 102 (described in greater detail below) for a greater fee, proportional to the search engine rankings.

In another embodiment of the present invention, the computer-readable removable medium (the CD/DVD 102 in the previous embodiments) takes on other forms, such as a diskettes, removable hard drives (mechanical or non-mechanical), smart disks, zip disks, mini-disks, tapes, flash memory sticks, or any other memory device, including electrical, optical, and chemical storage technologies.

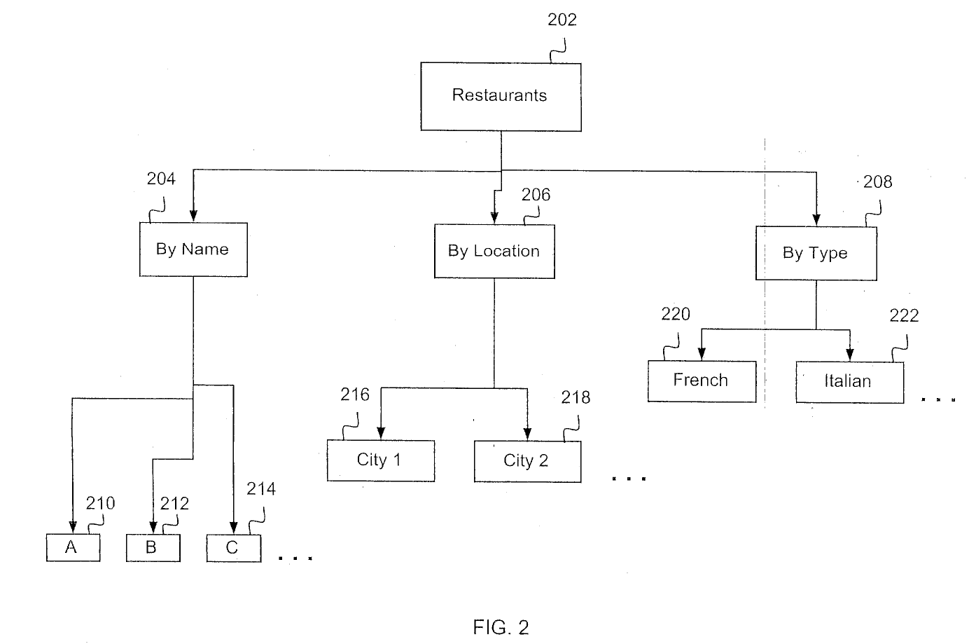

FIG. 2 is an organizational chart showing the logical arrangement of restaurant information on computer-readable removable media, in accordance with one embodiment of the present invention. FIG. 2 shows that at the first tier 202, the user is offered the opportunity to search information pertaining to restaurants. This information includes an address and telephone number, operating hours, a text description, driving directions, a map, a video showing the restaurant, a link to a web site of the restaurant and a review of the restaurant. This information also includes the type of restaurant (Mexican, Italian, etc.), a menu, a price range, a calendar of events for the restaurant and a web interface for placing a reservation at the restaurant.

FIG. 2 also shows at the next tier, the user is allowed to search for a restaurant by name 204, by location 206 and by type 208. If the user chooses to search for a restaurant by name 204, the user proceeds to the next tier 210-214. It is shown that at this tier, restaurants are organized alphabetically. Alternatively, at this tier, restaurants are organized in any fashion that allows searching restaurants by name. It is shown that all restaurants starting with the letter A are placed at location 210. Likewise, all restaurants starting with the letter B are placed at location 212, all restaurants starting with the letter C are placed at location 214, and so on. In an embodiment of the present invention, the user searches the alphabetized list of restaurant names using any number of mechanisms, such as a text matcher. A text matcher allows the user to enter text and then attempts to match the text to the restaurant names. Thus, the user enters a restaurant name and retrieves all restaurants containing the given text in their names.

If the user chooses to search for a restaurant by location 206, the user proceeds to the next tier 216-218. It is shown that at this tier, restaurants are organized by city name. Alternatively, at this tier, restaurants are organized in any fashion that allows searching restaurants by location, such as by county, by metropolitan area, by municipality, by zip code and by area code. It is shown that all restaurants located in a first city are placed at location 216. Likewise, all restaurants in a second city are placed at location 214, and so on. In an embodiment of the present invention, the user searches the restaurants organized by location using any number of mechanisms, such as a number matcher. A number matcher allows the user to enter numbers and then attempts to match the numbers to the zip codes of the restaurants. Thus, the user enters a zip code and retrieves all restaurants within that zip code.

If the user chooses to search for a restaurant by type 208, the user proceeds to the next tier 220-222. It is shown that at this tier, restaurants are organized by type of food served (French, Italian, etc.). Alternatively, at this tier, restaurants are organized in any fashion that allows searching by restaurant type, such as by level of formality, price range, indoor/outdoor dining and type of entertainment (live music, etc.). It is shown that all restaurants of a first type are placed at location 220. Likewise, all restaurants of a second type are placed at location 222, and so on. In an embodiment of the present invention, the user searches the restaurants organized by type by using any number of mechanisms, such as a text matcher. Thus, the user enters a restaurant type and retrieves all restaurants of that type.

In another embodiment of the present invention, as shown in FIG. 2, at the first tier 202 the user is offered the opportunity to search information pertaining to restaurants. In this embodiment, the user is allowed to search the restaurants by name, location and type simultaneously. A user interface is provided to the user to allow him to enter his search parameters. This is advantageous as the use of more than one search parameter results in the retrieval of fewer matches, as compared to using only one search parameter.

It should be noted that a database or index of establishment metadata is included in CD/DVD 102. That is, the database or index of establishment metadata includes all metadata for each establishment listed in the CD/DVD 102. The text matcher and the number matcher described above access the database or index of establishment metadata when performing a search on text or a number, respectively. For example, when the text matcher performs a search for a text string during a search-by-name search, for each establishment the text matcher reviews the establishment name metadata in the database or index. All matches are then returned to the user for further searching.

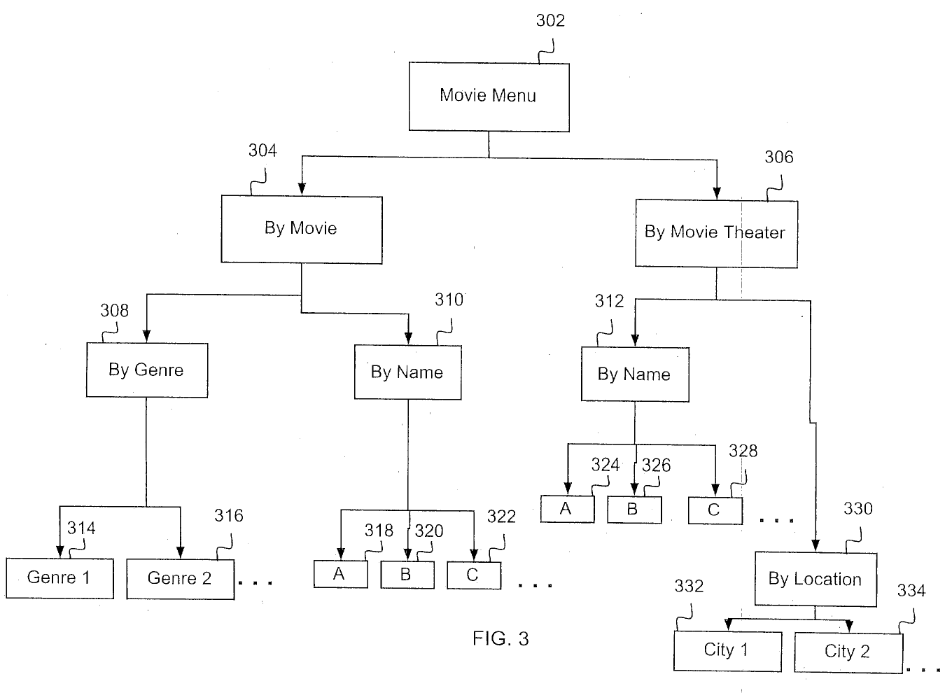

FIG. 3 is an organizational chart showing the logical arrangement of movie information on computer-readable removable media, in accordance with one embodiment of the present invention. FIG. 3 shows that at the first tier 302, the user is offered the opportunity to search information pertaining to movies. This information includes the following data pertaining to a movie theater: an address and telephone number, operating hours, a text description, driving directions, a map, a video showing the theater, a link to a web site of the theater and a review of the theater. This information also includes the following data pertaining to a movie: a text description, a rating, a list of celebrities in the movie, a movie review, a movie genre and a preview video of the movie.

FIG. 3 also shows at the next tier, the user is allowed to search for a movie either using movie information 304 or by using movie theater information 306. If the user chooses to search for a movie using movie information 304, the user proceeds to the next tier 308-310. At this tier, the user chooses whether he desires to search for a movie by genre 308 or by name 310. If the user chooses to search for a movie by genre 308, the user proceeds to the next tier 314-316. It is shown that at this tier, movies are organized by genre. It is shown that all movies of a first genre are placed at location 314. Likewise, all movies of a second genre are placed at location 316, and so on. In an embodiment of the present invention, the user searches the movies by genre by entering a genre and retrieving all movies of that genre.

If the user chooses to search for a movie by name 310, the user proceeds to the next tier 318-322. It is shown that at this tier, movies are organized alphabetically. Alternatively, at this tier, movies are organized in any fashion that allows searching movies by name. It is shown that all movies starting with the letter A are placed at location 318. Likewise, all movies starting with the letter B are placed at location 320, all movies starting with the letter C are placed at location 322, and so on. In an embodiment of the present invention, the user searches the alphabetized list of movie names using any number of mechanisms, such as a text matcher. Thus, the user enters a movie name and retrieves all movies containing the given text in their names.

If the user chooses to search for a movie using movie theater information 306, the user proceeds to the next tier 312, 330. At this tier, the user chooses whether he desires to search for a movie by movie theater name 312 or by movie theater location 330. If the user chooses to search for a movie by movie theater name 312, the user proceeds to the next tier 324-328. It is shown that at this tier, movie theaters are organized alphabetically. Alternatively, at this tier, movie theaters are organized in any fashion that allows searching movie theaters by name. It is shown that all movie theaters starting with the letter A are placed at location 324. Likewise, all movie theaters starting with the letter B are placed at location 326, all movie theaters starting with the letter C are placed at location 328, and so on. In an embodiment of the present invention, the user searches the alphabetized list of movie theater names using any number of mechanisms, such as a text matcher. Thus, the user enters a movie theater name and retrieves all movie theaters containing the given text in their names.

If the user chooses to search for a movie by movie theater location 330, the user proceeds to the next tier 332-334. It is shown that at this tier, movie theaters are organized by city name. Alternatively, at this tier, movie theaters are organized in any fashion that allows searching movie theaters by location, such as by county, by metropolitan area, by municipality, by zip code and by area code. It is shown that all movie theaters located in a first city are placed at location 332. Likewise, all movie theaters in a second city are placed at location 334, and so on. In an embodiment of the present invention, the user searches the movie theaters organized by location using any number of mechanisms, such as a number matcher. Thus, the user enters a zip code and retrieves all movie theaters within that zip code.

Example Screens

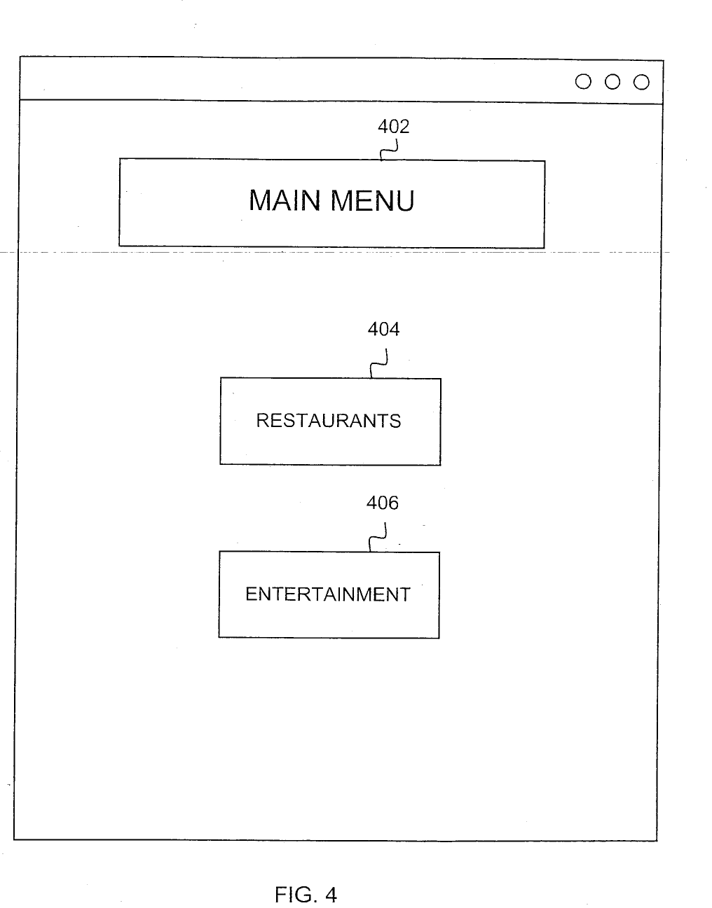

FIGS. 4-9 are examples of screens used for displaying product or service information and allowing a user to navigate through this information. The examples shown in FIGS. 4-9 are directed towards a CD or DVD containing product or service information that is stored as HTML files that are navigated using a web browser. As a result, the user is provided with standard web browser functions, such as the ability to return to the previous screen (a “back” button), the ability to return to the next screen (a “forward” button), etc. Thus, the experience of the user as he navigates through the product or service information is similar to the experience of navigating the Internet using a web browser.

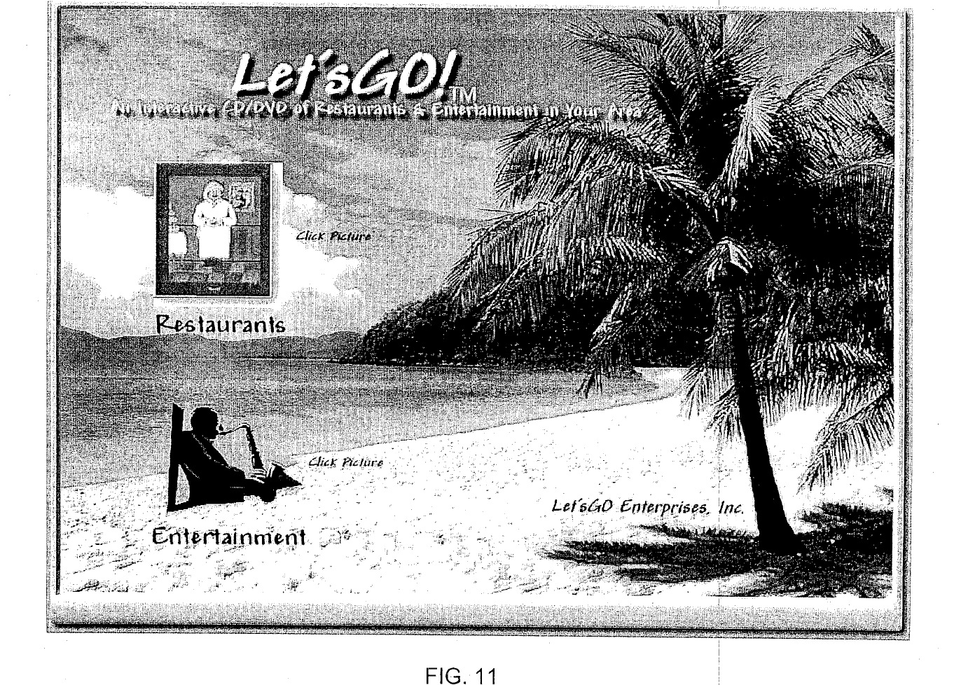

FIG. 4 is an illustration of a main menu screen for navigating product or service information on a CD, in accordance with one embodiment of the present invention. FIG. 4 shows a web browser displaying a main menu 402 page wherein the user is presented with options for navigation. The user is given the option of browsing through restaurant information 404 or entertainment (movies, theaters, etc.) information 406. The user utilizes a mouse to point and click on the option he desires. Once chosen, the user is presented with additional screens, described in greater detail below. FIG. 11 is an example screenshot of the main menu screen of FIG. 4.

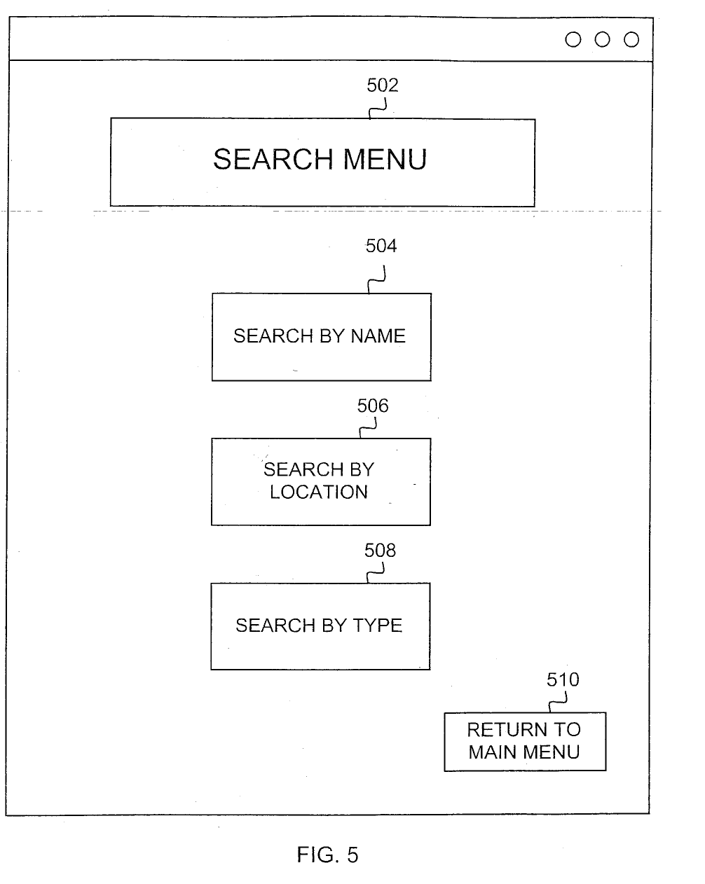

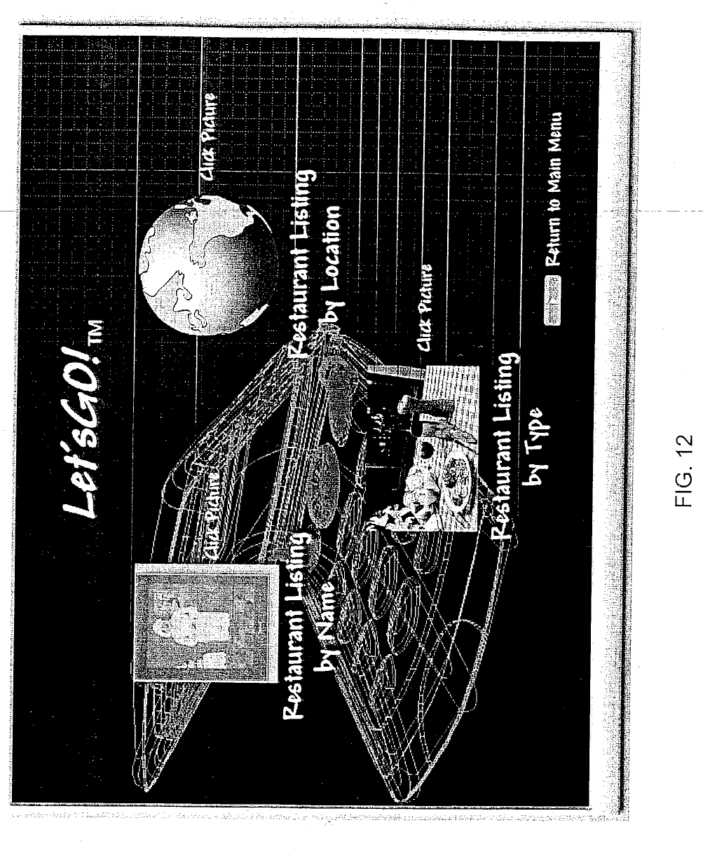

FIG. 5 is an illustration of a main restaurant search screen for navigating restaurant information on a CD or DVD, in accordance with one embodiment of the present invention. The user in FIG. 5 has chosen to browse the restaurant information 404, as presented in FIG. 4. FIG. 5 shows a web browser displaying a restaurant search menu 502 page wherein the user is presented with options for navigation. The user is given the option of searching for restaurants by name 504, by location 506 or by type 508. The user is also given the option of returning to the main menu 510, as shown in FIG. 4. The user utilizes a mouse to point and click on the option he desires. Once chosen, the user is presented with additional screens, described in greater detail below. FIG. 12 is an example screenshot of the main restaurant search screen of FIG. 5.

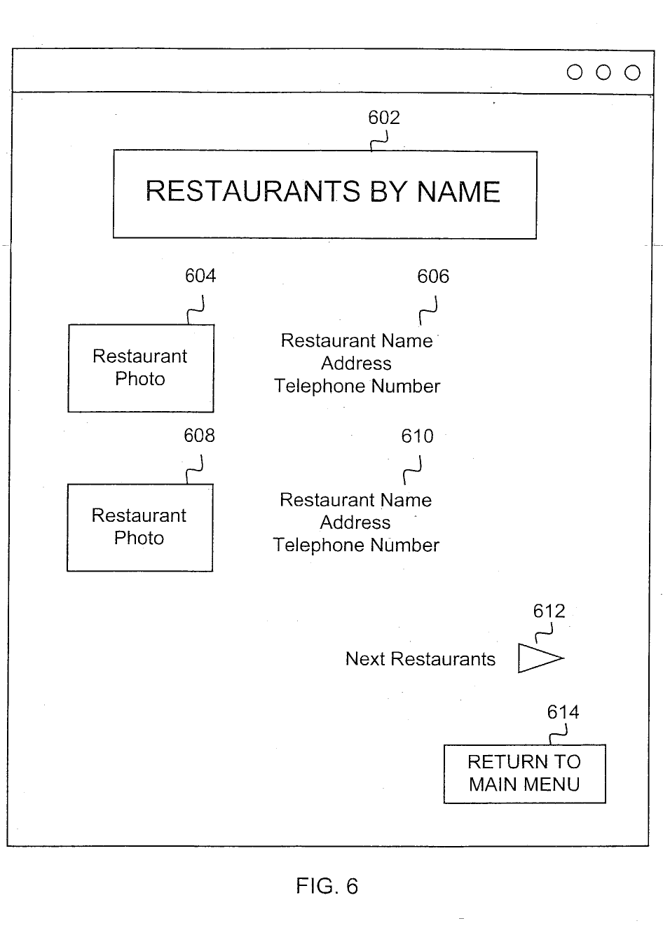

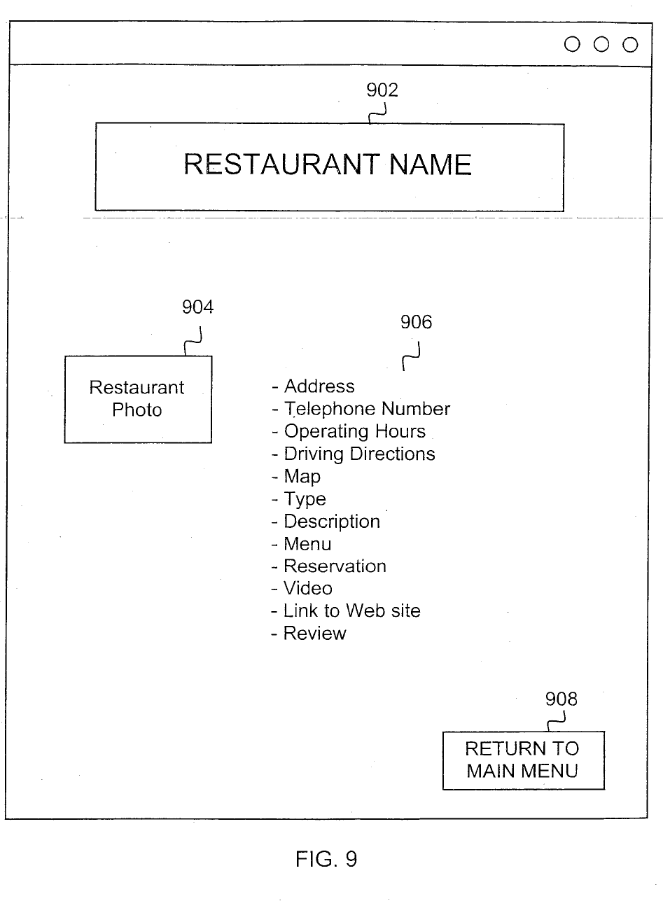

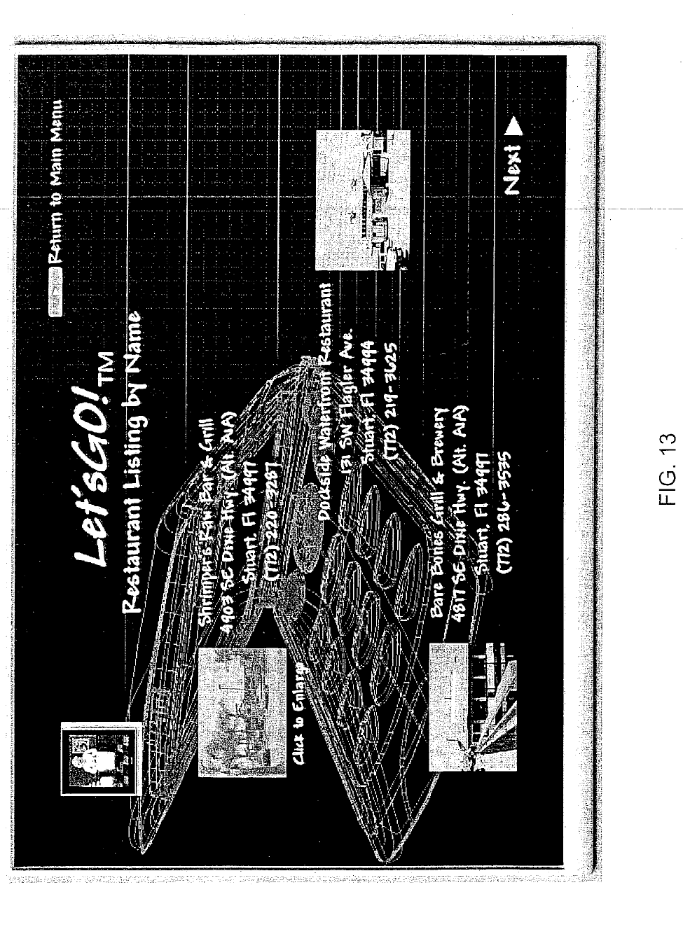

FIG. 6 is an illustration of a restaurant search by name screen for navigating restaurant information on a CD or DVD, in accordance with one embodiment of the present invention. The user in FIG. 6 has chosen to search for a restaurant by name 504, as presented in FIG. 5. FIG. 6 shows a web browser displaying a list of restaurants organized alphabetically by name. Each restaurant is presented using a photo 604, 608 and brief information about the restaurant 606, 610, such as restaurant name, address and telephone number. The user, however, utilizes a mouse to point and click on a restaurant to garner more information on that restaurant. Once chosen, the user is presented with an additional screen, described in greater detail in FIG. 9. FIG. 13 is an example screenshot of the restaurant search by name screen of FIG. 6.

The arrangement of the information in the web browser of FIG. 6 allows the user to scroll through the restaurants and find the restaurant he desires by finding the alphabetical location of the restaurant in the list. Because all restaurants cannot be displayed in one screen, a link 612 allows the user to view a subsequent screen displaying the next set of restaurants in the list. The user is also given the option of returning to the main menu 614, as shown in FIG. 4.

Alternatively, the screen includes a mechanism for searching the restaurants by name. For example, the screen includes a text field wherein text is entered by the user. The entered text is then compared with the entire list of restaurant names and any restaurants having matching restaurant names are displayed to the user for browsing.

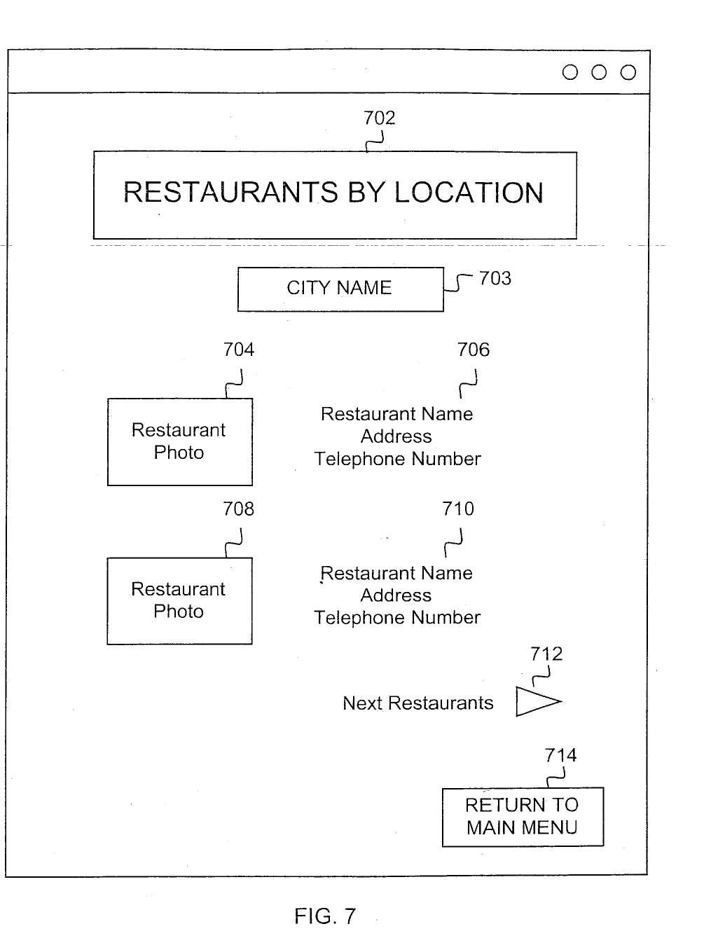

FIG. 7 is an illustration of a restaurant search by location screen for navigating restaurant information on a CD or DVD, in accordance with one embodiment of the present invention. The user in FIG. 7 has chosen to search for a restaurant by location 506, as presented in FIG. 5. FIG. 7 shows a web browser displaying a list of restaurants by location 702, organized by city name 703. Each restaurant is presented using a photo 704, 708 and brief information about the restaurant 706, 710, such as restaurant name, address and telephone number. The user utilizes a mouse to point and click on a restaurant to garner more information on that restaurant. Once chosen, the user is presented with an additional screen, described in greater detail in FIG. 9.

The arrangement of the information in the web browser of FIG. 7 allows the user to scroll through the restaurants and find the restaurant he desires by finding the city that he desires. Because all restaurants cannot be displayed in one screen, a link 712 allows the user to view a subsequent screen displaying the next set of restaurants, or the next city, in the list. The user is also given the option of returning to the main menu 714, as shown in FIG. 4.

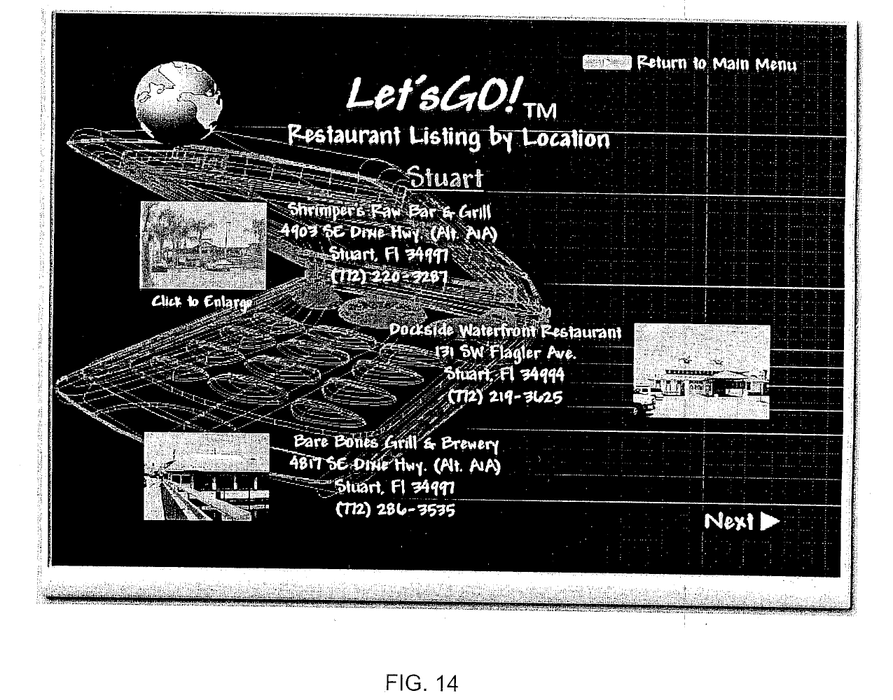

Alternatively, the screen includes a mechanism for searching the restaurants by location. For example, the screen includes a text field wherein the user enters a city name, a zip code or an area code. The entered information is compared to the restaurant information and any restaurants having a matching city name, zip code or area code are displayed to the user for browsing. FIG. 14 is an example screenshot of the restaurant search by location screen of FIG. 7.

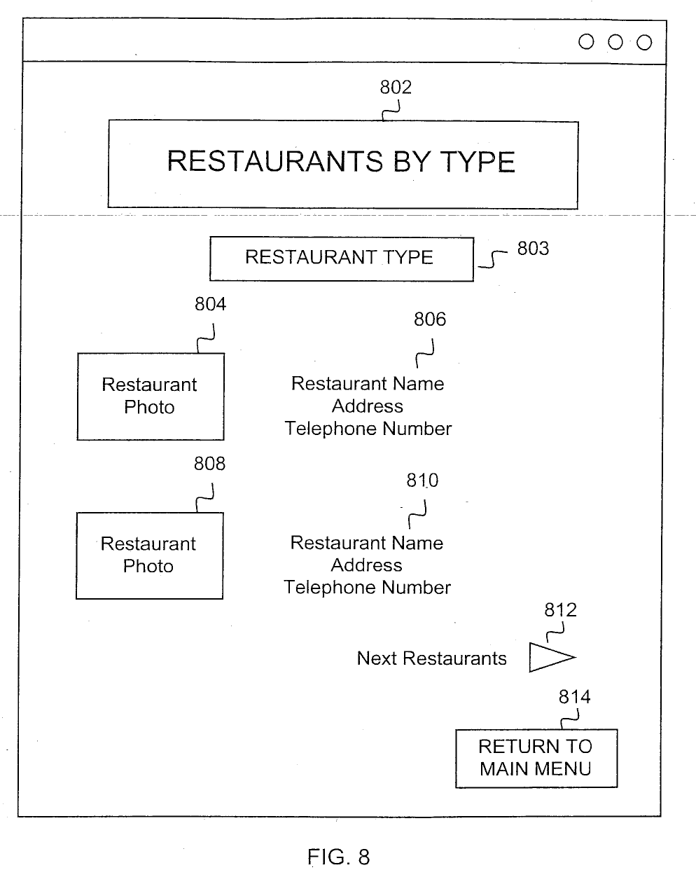

FIG. 8 is an illustration of a restaurant search by type screen for navigating restaurant information on a CD or DVD, in accordance with one embodiment of the present invention. The user in FIG. 8 has chosen to search for a restaurant by type 508, as presented in FIG. 5. FIG. 8 shows a web browser displaying a list of restaurants by type 802, organized by city name 803. Each restaurant is presented using a photo 804, 808 and brief information about the restaurant 806, 810, such as restaurant name, address and telephone number. The user utilizes a mouse to point and click on a restaurant to garner more information on that restaurant. Once chosen, the user is presented with an additional screen, described in greater detail in FIG. 9.

The arrangement of the information in the web browser of FIG. 8 allows the user to scroll through the restaurants and find the restaurant he desires by finding the restaurant type that he desires. Because all restaurants cannot be displayed in one screen, a link 812 allows the user to view a subsequent screen displaying the next set of restaurants, or the next restaurant type, in the list. The user is also given the option of returning to the main menu 814, as shown in FIG. 4.

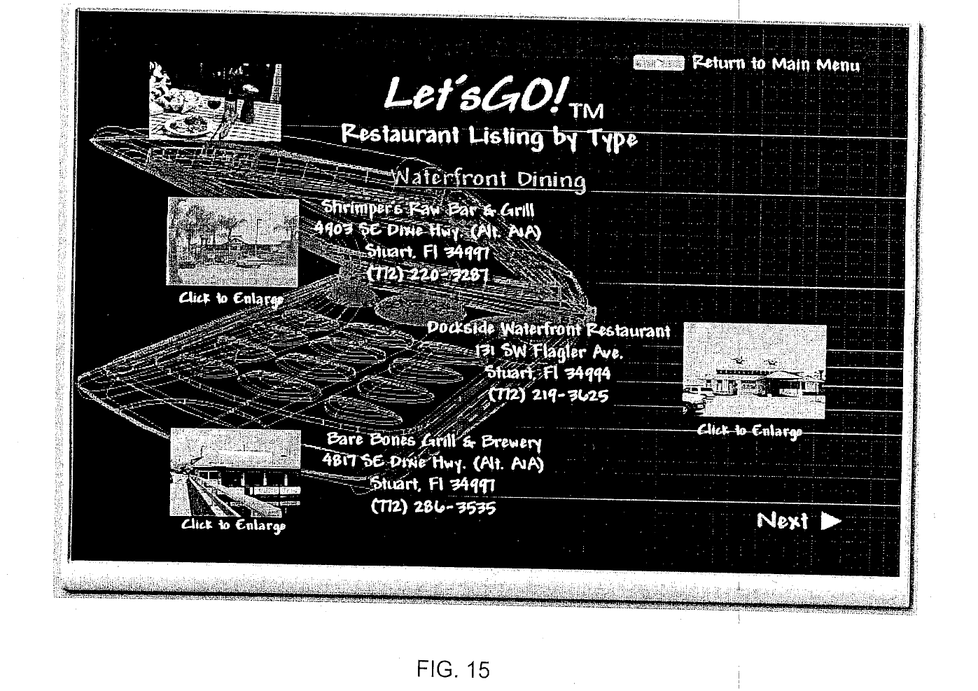

Alternatively, the screen includes a mechanism for searching the restaurants by type. For example, the screen includes a text field wherein the user enters a restaurant type. The entered information is compared to the restaurant information and any restaurants having a matching type are displayed to the user for browsing. FIG. 15 is an example screenshot of the restaurant search by type screen of FIG. 8.

FIG. 9 is an illustration of a restaurant information screen for viewing restaurant information on a CD or DVD, in accordance with one embodiment of the present invention. The user in FIG. 9 has chosen to gather more information on a particular restaurant 902, as presented in FIGS. 6-8. FIG. 9 shows a web browser displaying a set of information for one restaurant. The restaurant is presented using a photo 904 and metadata 906 about the restaurant 902. The user is also given the option of returning to the main menu 908, as shown in FIG. 4. The metadata 906 includes:

the restaurant address

the restaurant telephone number

the restaurant operating hours

driving directions to the restaurant

a map showing the restaurant; or a link to a web site having an interactive map (such as MapQuest) showing the restaurant

the restaurant type (French, Italian, etc.)

a text description of the restaurant

the restaurant menu

the price range of the food sold at the restaurant

a list of credit cards accepted at the restaurant

a calendar of events occurring at the restaurant

a mechanism for placing a reservation at the restaurant, such as a reservation email address or a CGI script for accepting reservation requests

a video showing the restaurant in a virtual visit

a URL link or a web address for the restaurant's website

a critical review of the restaurant

Because all additional information 906 is not displayed in one screen, the user utilizes a mouse to point and click on an item to garner more information. For example, the user clicks on the video item to play the video of the restaurant in a virtual visit. Because the video information is located on the CD/DVD 102 and there is no Internet or network connection involved, there are no bandwidth requirements to meet. This is an advantage over the use of the Internet, which typically involves a bandwidth requirement that must be met in order to experience true real time video.

Exemplary Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, flash memory, disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

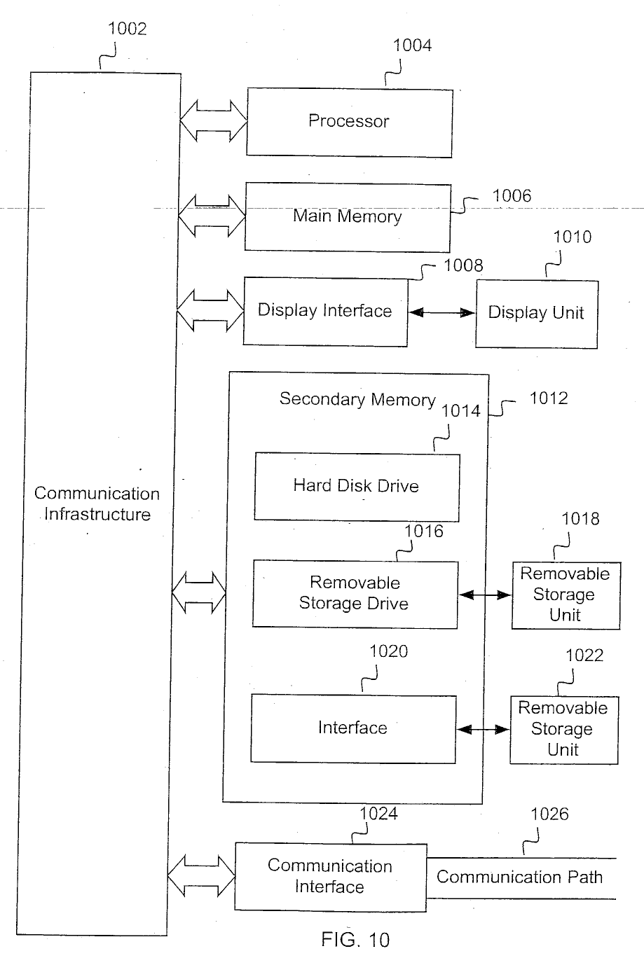

FIG. 10 is a block diagram of a computer system useful for implementing an embodiment of the present invention. The computer system includes one or more processors, such as processor 1004. The processor 1004 is connected to a communication infrastructure 1002 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1008 that forwards graphics, text, and other data from the communication infrastructure 1002 (or from a frame buffer not shown) for display on the display unit 1010. The computer system also includes a main memory 1006, preferably random access memory (RAM), and may also include a secondary memory 1012. The secondary memory 1012 may include, for example, a hard disk drive 1014 and/or a removable storage drive 1016, representing a floppy disk drive, a magnetic tape drive, an optical disk drive, etc. The removable storage drive 1016 reads from and/or writes to a removable storage unit 1018 in a manner well known to those having ordinary skill in the art. Removable storage unit 1018, represents a floppy disk, magnetic tape, optical disk, etc. which is read by and written to by removable storage drive 1016. As will be appreciated, the removable storage unit 1018 includes a computer usable storage medium having stored therein computer software and/or data.

In alternative embodiments, the secondary memory 1012 may include other similar means for allowing computer programs or other instructions to be loaded into the computer system. Such means may include, for example, a removable storage unit 1022 and an interface 1020. Examples of such may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to the computer system.

The computer system may also include a communications interface 1024. Communications interface 1024 allows software and data to be transferred between the computer system and external devices. Examples of communications interface 1024 may include a modem, a network interface (such as an Ethernet card), a communications port, a PCMCIA slot and card, etc. Software and data transferred via communications interface 1024 are in the form of signals which may be, for example, electronic, electromagnetic, optical, or other signals capable of being received by communications interface 1024. These signals are provided to communications interface 1024 via a communications path (i.e., channel) 1026. This channel 1026 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1006 and secondary memory 1012, removable storage drive 1016, a hard disk installed in hard disk drive 1014, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 1006 and/or secondary memory 1012. Computer programs may also be received via communications interface 1024. Such computer programs, when executed, enable the computer system to perform the features of the present invention as discussed herein. In particular, the computer programs, when executed, enable the processor 1004 to perform the features of the computer system. Accordingly, such computer programs represent controllers of the computer system.

### CONCLUSION

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A computer-readable removable medium including computer instructions for advertising products and services, the computer instructions including instructions for:
providing metadata associated with establishments located in a predefined geographical area, including establishments that pay to be listed and establishments that do not pay to be listed;
searching the establishments by name, type and location; and
providing coupons for at least one of discounted product and a discounted service at the establishments that are listed.

2. The computer-readable removable medium of claim 1, wherein the establishments are any one of restaurants, hotels, movie theaters, nightclubs, retail shops and theme parks.

3. The computer-readable removable medium of claim 2, wherein the computer-readable removable medium is a Compact Disc (CD) or a Digital Versatile Disc (DVD).

4. The computer-readable removable medium of claim 3, wherein the geographical area includes any one of a city, a political subdivision, a county, a metropolitan area, a zip code and an area code.

5. The computer-readable removable medium of claim 4, wherein the metadata includes one or more of the following:
an address and telephone number;
operating hours;
a text description;
driving directions;
a map;
a video showing the establishment;
a link to a web site of the establishment; and
a review of the establishment.

6. The computer-readable removable medium of claim 5, wherein an establishment that is listed pays a fee when a coupon for at least one of discounted product and a discounted service at the establishment is included in the computer-readable removable medium and wherein the fee is proportional to the amount of coupons that are included.

7. The computer-readable removable medium of claim 6, wherein an establishment that is listed pays a fee when additional metadata is included in the computer-readable removable medium and wherein the fee is proportional to the amount of additional metadata that is included.

8. The computer-readable removable medium of claim 7, wherein a computer-readable removable medium including updated information is provided each month.

9. The computer-readable removable medium of claim 1, wherein the establishments are restaurants.

10. The computer-readable removable medium of claim 9, wherein the computer-readable removable medium is a Compact Disc (CD) or a Digital Versatile Disc (DVD).

11. The computer-readable removable medium of claim 10, wherein the geographical area includes any one of a city, a political subdivision, a county, a metropolitan area, a zip code and an area code.

12. The computer-readable removable medium of claim 11, wherein the metadata includes one or more of the following:
an address and telephone number;
operating hours;
a text description;
a menu;
driving directions;
a map;
a video showing the establishment;
a link to a web site of the establishment;
a control for placing a reservation via the Internet; and
a review of the establishment.

13. The computer-readable removable medium of claim 12, wherein an establishment that is listed pays a fee when a coupon for at least one of discounted product and a discounted service at the establishment is included in the computer-readable removable medium and wherein the fee is proportional to the amount of coupons that are included.

14. The computer-readable removable medium of claim 13, wherein an establishment that is listed pays a fee when additional metadata is included in the computer-readable removable medium and wherein the fee is proportional to the amount of additional metadata that is included.

15. The computer-readable removable medium of claim 14, wherein a computer-readable removable medium including updated information is provided each month.

16. A method for advertising products and services, the method comprising:
producing a computer-readable removable medium including computer instructions for advertising products and services, the computer instructions including instructions for:
providing metadata associated with establishments located in a predefined geographical area, including establishments that pay to be listed and hospitality that do not pay to be listed;
searching the establishments by name, type and location; and
providing coupons for at least one of discounted product and a discounted service at the establishments that are listed.

17. The method of claim 16, wherein the establishments are restaurants.

18. The method of claim 17, wherein the computer-readable removable medium is a Compact Disc (CD) or a Digital Versatile Disc (DVD).

19. The method of claim 18, wherein the geographical area includes any one of a city, a political subdivision, a county, a metropolitan area, a zip code and an area code.

20. An information processing system for advertising products and services, comprising:
a computer-readable removable medium including computer instructions for advertising products and services, the computer instructions including instructions for:
providing metadata associated with establishments located in a predefined geographical area, including establishments that pay to be listed and establishments that do not pay to be listed;
searching the establishments by name, type and location; and
providing coupons for at least one of discounted product and a discounted service at the establishments that are listed.

21. The system of claim 20, wherein the establishments are restaurants.

22. The system of claim 21, wherein the computer-readable removable medium is a Compact Disc (CD) or a Digital Versatile Disc (DVD).

23. A computer-readable removable medium including computer instructions for advertising products and services, the computer instructions including instructions for:
providing metadata associated with establishments associated with a products and services category, including establishments that pay to be listed and establishments that do not pay to be listed;
searching the establishments by name, type and location; and
providing coupons for at least one of discounted product and a discounted service at the establishments that are listed.
